(19) United States
(12) Patent Application Publication
(10) Pub. No.: US 2002/0150331 A1
(43) Pub. Date: Oct. 17, 2002

(54) Hybridised fibre amplifier/waveguide structures

(76) Inventors: Andrew Tomlinson, Oxford (GB); Jolyon Tidmarsh, Oxford (GB)

Correspondence Address: Mark D. Saralino, Nineteenth Floor, 1621 Euclid Avenue, Cleveland, OH, 44115-2191, US

(21) Appl. No.: 10/119,167

(22) Filed: Apr. 9, 2002

(30) Foreign Application Priority Data
Apr. 9, 2001 (GB) 0108883.0

(51) Int. Cl. G02B 6/26; G02B 6/12

(52) U.S. Cl. 385/27; 385/15; 385/14; 359/333

(57) ABSTRACT

A hybridized fiber amplifier/waveguide system for amplifying a multichannel signal comprises a planar waveguide structure (1) incorporating a pump laser (2) providing an output signal of a defined wavelength, a doped optical fiber (8) attached to the structure and having an absorption wavelength corresponding to the wavelength of the laser output signal, and coupling means (5) for supplying the output signal of the laser and the multichannel signal to the doped fiber to amplify the multichannel signal.

### BACKGROUND OF THE INVENTION

The present invention relates to hybridised fibre amplifier/waveguide structures.

Accelerating development within the information technology (IT) field demands newer and better technologies to support communication and computer data transmission and processing. One such technology is optical communications, and one of the methods for increasing data rates in optical communications is wavelength division multiplexing (WDM) in which different data channels within a light signal transmitted along a single optical fibre or waveguide are differentiated according to the wavelength band of the transmitted light corresponding to that channel. Signal processing in such WDM systems involves multiple combination and/or separation of the individual multiplex channels using multiplexer/demultiplexer devices.

Generally the multiplexed signals in such WDM systems are amplified by being supplied to a fibre amplifier comprising a pump laser, drive electronics and a length of fibre doped with a rare earth element, such as erbium. The amplification of the multiplexed signal occurs within the doped fibre which is connected to the output of the pump laser. This is done in an equipment rack, the multiplexer and the fibre amplifier being connected together by one or more optical fibres. However such an arrangement uses a relatively large number of components, and is not particularly compact.

A significant amount of research is being undertaken in the field of silica planar waveguide structures to enable the silica waveguide material to be doped with erbium or other rare-earth elements to produce on-chip amplification of WDM signals. This approach has benefits in terms of a lower component count in the device. One disadvantage of such structures, however, is that they rely on providing a long length of waveguide on the chip to achieve the amplification and thus make the chip area larger. Such structures are also not suitable for use with an active silicon optical chip technology because rare earth elements in silicon and other crystalline compounds produce narrow-band amplification.

A further alternative is to use semiconductor optical amplifiers for such amplification. However semiconductor optical amplifiers are not well-suited to WDM systems because the semiconductor gain is strongly coupled to the optical mode and is homogeneously broadened. This gives rise to high cross-talk unless the signal is first demultiplexed.

It is an object of the invention to provide a hybridised laser/fibre amplifier which can be produced at low cost, and which is particularly suitable for use in dense wavelength division multiplexing (DWDM) optical communication systems.

### SUMMARY OF THE INVENTION

According to the present invention there is provided a hybridised fibre amplifier/waveguide system for amplifying a multichannel signal, the system comprising a planar waveguide structure incorporating a pump laser providing an output signal of a defined wavelength, a doped optical fibre attached to the structure and having an absorption wavelength corresponding to the wavelength of the laser output signal, and coupling means for supplying the output signal of the laser and the multichannel signal to the doped fibre to amplify the multichannel signal.

In this system amplification is achieved using a separate fibre amplifier comprising a length of doped optical fibre attached to the structure. The multichannel signal is efficiently coupled by the coupling means within the device to light from the laser, which is typically a 980 nm or 1480 nm pump laser in the case where the fibre amplifier is doped with erbium. The coupling of the light supplied by the pump laser to the multichannel signal thereby amplifies the multichannel signal within the fibre amplifier.

Rather than trying to achieve gain in the waveguide structure, the equivalent effect is achieved by hybridising the pump laser onto the planar waveguide structure. This is possible by providing a recess in the waveguide structure for receiving a laser chip in such a manner that the output signal from the laser chip is received by the waveguide structure. Ideally the optical power from the laser is coupled to the fibre with the multichannel signal by means of a wavelength selective coupler fabricated on the planar waveguide structure, such as a path imbalanced Mach-Zehnder interferometer. The standard input fibre can then be replaced by a highly rare-earth doped fibre such as the one described in B. N. Samson et al., Electronics Letters, 34(1), 111 (1998) who reported 1.2 dB cm⁻¹ optical gain. Therefore a ˜50 cm fibre pigtail that is commonly attached to the input of a demultiplexer or the output of a multiplexer can be used to provide amplification and replace an external optical amplifier saving on system cost and complexity, as well as reducing power consumption.

The waveguide structure can be easily integrated in a waveguide-based optical chip, such as an active silicon optical chip for example, without requiring a large number of additional manufacturing steps.

In one embodiment of the invention the doped optical fibre forms part of an output connector of the system. In this embodiment the system generally includes a multiplexer for converting a plurality of input signals to the multichannel signal, the multichannel output signal of the multiplexer being supplied to the doped optical fibre along with the laser output signal.

In another embodiment of the invention the doped optical fibre forms part of an input connector of the system. In this embodiment the system generally includes a demultiplexer for converting the multichannel signal to a plurality of output signals, the multichannel input signal to the demultiplexer being supplied to the doped optical fibre along with the laser output signal.

The invention also provides a hybridised fibre amplifier/waveguide system for amplifying a multichannel signal, the system comprising a planar waveguide structure, a doped optical fibre attached to the structure and having an absorption wavelength corresponding to the wavelength of a laser output signal, coupling means for supplying the laser output signal and the multichannel signal to the doped fibre to amplify the multichannel signal, and variable attenuating means for equalising the gains of the channels of the multichannel signal.

### BRIEF DESCRIPTION OF THE DRAWINGS

For a better understanding of the invention and to show how the same may be carried into effect, reference will now be made, by way of example, to the accompanying drawings, in which:

FIG. 1 is a schematic diagram of an exemplary embodiment of a hybridised fibre amplifier/waveguide structure in accordance with the invention; and

FIG. 2 is a view of an electronic variable optical attenuator (EVOA).

### DETAILED DESCRIPTION OF THE DRAWINGS

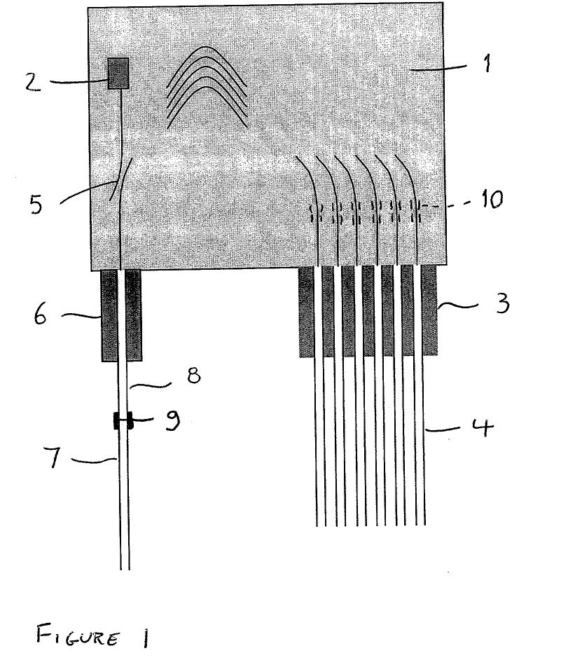

The planar waveguide structure shown in FIG. 1 is produced by silicon-on-insulator (SOI) technology and comprises a multiplexer chip 1 and an integral 1480 nm laser chip 2 hybridised onto the planar waveguide structure. The planar waveguide structure may alternatively be produced on silica. In either case, however, the III-IV crystal material used for the emitter/detector of the laser cannot be grown directly onto the structure, and hence the need for hybridisation of the multiplexer chip and the laser chip on a common platform. In this case the laser chip is fitted within a specially formed recess in the planar waveguide structure in such a manner as to provide the required accurate alignment between the laser chip and the multiplexer chip. The complete structure is encapsulated within a standard package (not shown).

The multiplexer chip 1 has a plurality of inputs connected to a multi-way fibre input connector 3 to which corresponding standard input optical fibres 4 are connected in conventional manner. The input signals supplied along the input fibres 4 are combined in the multiplexer chip 1 so as to produce a WDM output signal incorporating a corresponding number of channels. The WDM output signal is supplied to one input of a wavelength selective coupler 5 consisting of two closely adjacent waveguide sections fabricated on the planar waveguide structure in such a manner as to provide wavelength-dependent optical coupling of signals transmitted along the sections in known manner. A suitable type of coupler for this application would be a path imbalanced Mach-Zehnder interferometer (MZI). However other types of coupler could alternatively be used, such as an evanescent coupler, a Y-coupler, etc. The laser chip 2 is connected to the other input of the coupler 5 so that the optical power from the laser is coupled to an output connector 6 of the structure along with the WDM output signal.

The output connector 6 comprises a standard fibre connector block attached to the facet of the multiplexer chip 1 to which there is connected a length (typically of the order of 50 cm, although it may be much longer) of a highly-doped optical fibre 8 forming a pigtail connector, and a standard optical fibre 7 is connected to the output connector 6 by means of a fibre connector element 9 in known manner. The fibre 8 is doped with a rare earth element, such as erbium for example. The 1480 nm optical output signal from the coupler 5 serves to pump the doped optical fibre 8 forming part of the output connector 6, and thus produces an amplified output signal incorporating the multiplexed channels which is supplied to the fibre 7. The 1480 nm optical output signal is absorbed by the fibre 8 while the amplified multiplexed signals are transmitted to the fibre 7.

Optionally the waveguides on the multiplexer chip 1 receiving the input signals from the input fibres 4 incorporate variable optical attenuators (VOAS) 10 which serve to attenuate the signals to different extents so as to equalise the gains of the channels in the multichannel signal outputted from multiplexer chip 1. The degree to which each VOA 10 attenuates the associated input signal can be controlled by an electronic control circuit in dependence on the output of optical sensors by detecting the amplified multiplexed output signal of the fibre amplifier and supplying electrical feedback signals indicative of the EDFA gain tilt of the fibre amplifier to the control circuit. The attenuation of the input signals by the VOAs is controlled so as to compensate for such gain tilt such that the channels of the resulting WDM output signal outputted by the fibre 7 have substantially equal gains. It should be understood that the VOAs may be electronic VOAs (EVOAs) or other forms of VOAs such as for example Mach-Zehnder interferometers.

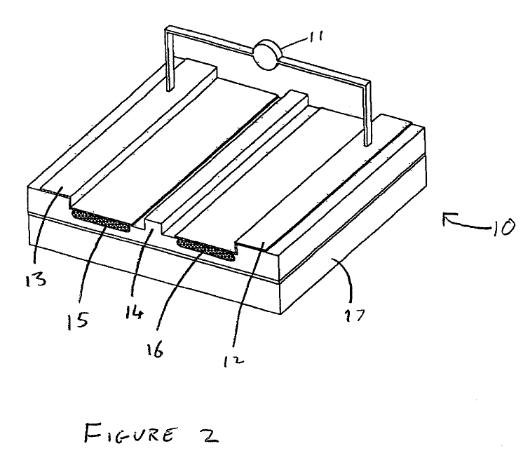

FIG. 2 shows a perspective view of a typical EVOA 10. An electrical source 11 is connected to metal tracks 12, 13 on a chip 17. Each side of a waveguide 14 are buried doped regions 15, 16 with a p-type region 15 on one side and an n-doped region 16 on the other. The metal tracks 12, 13 are in contact with the doped regions 15, 16 so that carriers are injected into the waveguide. The chip is typically silicon-on-insulator but could be formed of other semiconductor materials.

The attenuators may be provided as single or multiple units. Mach-Zehnder interferometers are normally used as single units whereas, for optimal power consumption, four EVOAs 10 are placed in series on each arm or channel. In such a case the doping is alternate—i.e. p n p n down each side and across the waveguides 14.

The above description is concerned with a multiplexer structure for multiplexing a plurality of input signals to produce a single multiplexed output signal. However a similar arrangement could be used for a demultiplexer structure in which a single multiplexed input signal is converted to a plurality of distinct output signals, in which case the doped fibre is provided at the input of the structure. In the case of a demultiplexer structure VOAs may also optionally be provided to compensate for the EDFA gain tilt of the fibre amplifier, and the attenuation of the VOAs may be controlled in dependence of the outputs of optical sensors detecting the demultiplexed output signals. Although a 1480 nm laser is used in the implementation described with reference to FIG. 1, a 980 nm laser could be used to pump an erbium-doped fibre in certain applications, and lasers of other wavelengths may be used in other implementations in which other rare earth elements are used for doping the fibre provided that the wavelength corresponds to an absorption wavelength of the doped fibre.

In a preferred method for fabricating the planar waveguide structure incorporating the laser chip, the structure is formed from standard SOI material which typically comprises a 5 micron silicon layer on a 0.4 micron thick buried oxide layer on a silicon substrate. The waveguide sections and a recess for the laser chip are formed in the silicon layer simultaneously utilising a single masking, exposing and etching sequence. The waveguide sections have typical cross-sections of a width of about 4 microns and a height of about 2 microns, and the recess has a typical area of the order of 350 microns by 300 microns for accommodating a laser chip of typical dimensions. The laser chip has an emission area of a few microns, e.g. 2×4 microns or 3×8 microns, which is aligned with the appropriate waveguide section on the structure by virtue of the engagement of the edges of the laser chip with two side walls and an end wall of the recess. Due to the high selectivity between oxide and silicon, either surface of the buried oxide layer can act as an etch stop, thus allowing accurate definition of the depth of the recess and thus the height of the laser chip relative to the waveguide sections. The laser chip is provided with electrical contacts on its base which are connected by solder or other conductive material to a conductive pad at the bottom of the recess. Further details of such a fabrication method are given in U.S. Pat. No. 5,881,190.

The concept of hybridising the laser and pigtailing the chip with the fibre amplifier can be incorporated in any multichannel chip where all the channels to be amplified pass through the same fibre pigtail. For example such a system may be used in a multichannel laser transmitter, the channels being combined by a set of Y-junctions and all the channels being amplified in a single output fibre.

The hybridised fibre amplifier/waveguide structure of the invention is particularly suitable for use in dense wavelength division multiplexing (DWDM) optical communication systems, such as multichannel transceivers. Such a structure has a smaller footprint, and renders the use of an external optical amplifier unnecessary, thus saving on system cost and complexity. Since the pump laser and the fibre form integral parts of the multiplexer/demultiplexer, fewer fibre connections need to be made as compared with existing arrangements using an independent fibre amplifier. Such a structure also removes the need to develop a suitable amplifier to be mounted on the planar waveguide structure. The same chip also provides efficient coupling from the laser to the doped fibre. In addition the structure is a particularly compact structure, using significantly less components than other systems available for providing such amplification, and is thus significantly less costly to produce. The fact that the laser and the multiplexer/demultiplexer use a common package also reduces power consumption.

It will be understood that variations from the preferred embodiment described above will still fall within the scope of the invention. For example, the system is described as having optical fibres 4 connected to a multi-way fibre connector to provide the input signal (or receive the output signal if the system is used as a demultiplexer). However, it will be appreciated that the input signals could be provided by lasers provided directly on the multiplexer chip 1. If the system is used as a demultiplexer, receivers could be mounted directly on the chip in place of the output fibres 4.

1. A hybridised fibre amplifier/waveguide system for amplifying a multichannel signal, the system comprising a planar waveguide structure incorporating a pump laser providing an output signal of a defined wavelength, a doped optical fibre attached to the structure and having an absorption wavelength corresponding to the wavelength of the laser output signal, and coupling means for supplying the output signal of the laser and the multichannel signal to the doped fibre to amplify the multichannel signal.

2. A system according to claim 1, wherein the doped optical fibre forms part of an output connector of the system.

3. A system according to claim 1, wherein the doped optical fibre forms part of an input connector of the system.

4. A system according to claim 1, which includes a multiplexer for converting a plurality of input signals to the multichannel signal.

5. A system according to claim 1, which includes a demultiplexer for converting the multichannel signal to a plurality of output signals.

6. A system according to claim 4, wherein variable attenuating means is provided for equalising the gains of the input/output signals.

7. A system according to claim 6, wherein the variable attenuating means comprises a plurality of variable optical attenuators (VOAs).

8. A system according to claim 1, wherein the coupling means is a Mach-Zehnder interferometer (MZI).

9. A system according to claim 1, wherein the coupling means is an evanescent coupler.

10. A system according to claim 1, wherein the coupling means is a Y-coupler.

11. A system according to claim 1, wherein the optical fibre is doped with a rare earth element.

12. A system according to claim 11, wherein the rare earth element is erbium.

13. A system according to claim 1, wherein the laser is fabricated on a chip which is accommodated in a recess formed in the planar waveguide structure.

14. A system according to claim 13, wherein a multiplexer or demultiplexer is integrally formed on the planar waveguide structure with the coupling means.

15. A system according to claim 1, wherein the length of the optical fibre is between 10 and 100 centimeters, and is preferably about 50 centimeters.

16. A system according to claim 1, which is formed by silicon-on-insulator (SOI) technology.

17. A system according to claim 1, which is incorporated in a dense wavelength division multiplexing (DWDM) system.

18. A hybridised fibre amplifier/waveguide system for amplifying a multichannel signal, the system comprising a planar waveguide structure, a doped optical fibre attached to the structure and having an absorption wavelength corresponding to the wavelength of a laser output signal, coupling means for supplying the laser output signal and the multichannel signal to the doped fibre to amplify the multichannel signal, and variable attenuating means for equalising the gains of the channels of the multichannel signal.
